(19) United States
(12) Patent Application Publication
(10) Pub. No.: US 2022/0166900 A1
(43) Pub. Date: May 26, 2022

(54) Calibration transition in the printing direction

(71) Applicant: Hewlett-Packard Development Company, L.P., Spring, TX (US)

(72) Inventors: Carlos Fajardo Sanchez, Sant Cugat del Valles (ES); Joan Vidal Fortia, Sant Cugat del Valles (ES); Ivan Perez Laka, Sant Cugat del Valles (ES)

(73) Assignee: Hewlett-Packard Development Company, L.P., Spring, TX (US)

(21) Appl. No.: 17/419,338

(22) PCT Filed: Jul. 15, 2019
(86) PCT No.: PCT/US2019/041776

§ 371 Date: Jun. 29, 2021

(51) Int. Cl. H04N 1/60; G06K 15/02

(52) U.S. Cl. CPC H04N 1/6041; G06K 15/027

(57) ABSTRACT

A method of calibrating a printing device, wherein the method comprises: associating a weighted printing value to each of a plurality of pixels, wherein associating a weighted printing value to each pixel comprises: obtaining, from a first calibration table, a first calibration value; obtaining, from a second calibration table, a second calibration value; obtaining first and second weighting factors, wherein the first weighting factor is obtained from a weighting table, generating the weighted printing value as the sum of the first calibration value weighted with the first weighting factor and the second calibration value weighted with the second weighting factor.

### BACKGROUND

Calibration is used in printers to compensate for printing irregularities that may arise due to a number of variability sources, both ink-related, like variations in ink drop weight, ink chemistry and ink environmental conditions, such as temperature and humidity, and printer-related, like aerodynamic variations, temperature fluctuations between different print dies, differences in nozzle size or shape and misalignments between different print dies. All these factors affect the final color appearance of a finished printing job on a print medium.

Further factors can result from the directionality defined by the relative movement of a print medium, like paper, with respect to the printhead. For instance, mechanical actuations upon a print medium, like vacuum for securing the print medium or airflow for improving printing uniformity, may differently affect different parts of the geometry of the print medium. In particular, the uppermost part of the print medium, which is exposed to such actuations prior to other parts of the print medium, may be differently affected than the rest of the print medium.

### BRIEF DESCRIPTION OF THE FIGURES

FIG. 1 is a schematic illustration of a print medium according to an example.

FIG. 2 is a schematic illustration of a plurality of pixels according to an example.

FIG. 3 is a schematic illustration of first and second calibration tables according to an example.

FIG. 4 is a schematic illustration of a weighting table according to an example.

FIG. 5 is a flow diagram representing a method of calibrating a printing device according to an example.

FIG. 6 is a schematic illustration of a print medium according to an example.

FIG. 7 is a flow diagram representing a method of calibrating a printing device according to an example.

FIG. 8 is a schematic illustration of a print medium according to an example.

FIG. 9 is a schematic illustration of a calibration module according to an example.

FIG. 10 is a schematic illustration of a printing device according to an example

### DETAILED DESCRIPTION

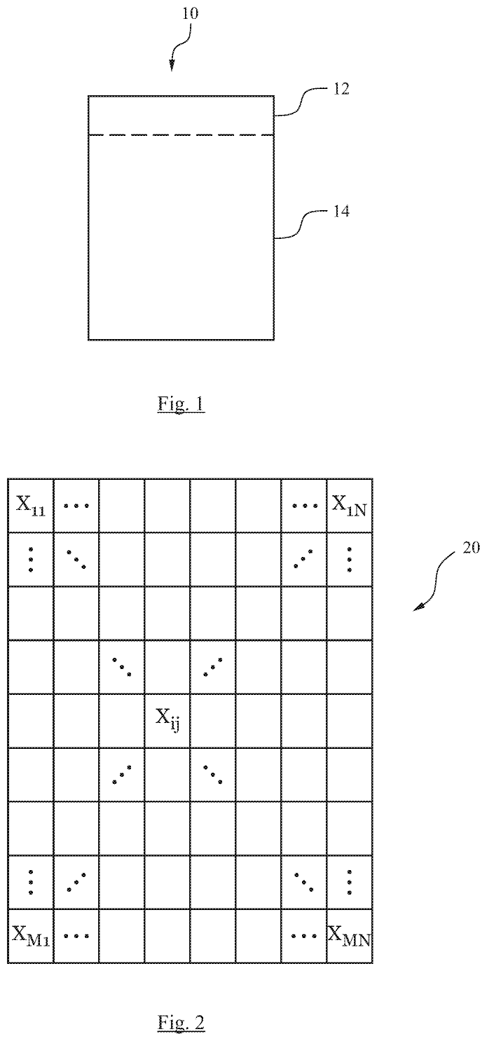

FIG. 1 is a schematic illustration of a print medium 10 according to an example. The print medium 10 may correspond in some examples to a sheet of paper, carton, plastic, fabric, or any other printable material. The print medium is divided along a direction P in a first zone 12 and a second zone 14. The direction P signals the direction in which the print medium 10 may move or be conveyed during a printing process in a printing device. Thus, in a printing process, when the print medium 10 moves in the direction P, the first zone 12 is printed before the second zone 14 is printed.

According to some examples, the first zone 12 may be a leading edge zone of the print medium 10 and may comprise an uppermost boundary or leading boundary of the print medium 10 as regarded in the direction of movement P, and the second zone 14 may be a rest zone of the print medium 10 comprising a remainder of the print medium 10 not comprised in the leading edge zone or a part thereof. The first and second zones 12, 14 may however correspond to any two different parts of the print medium 10, in particular covering different extensions of the print medium 10 in the direction of movement P, not necessarily to a leading edge zone comprising a leading edge of the print medium 10 and a rest zone. The first zone may comprise 5%, 10%, 15%, 20%, 25%, or 30% of the length of the print medium 10 along the direction of movement P of the print medium 10.

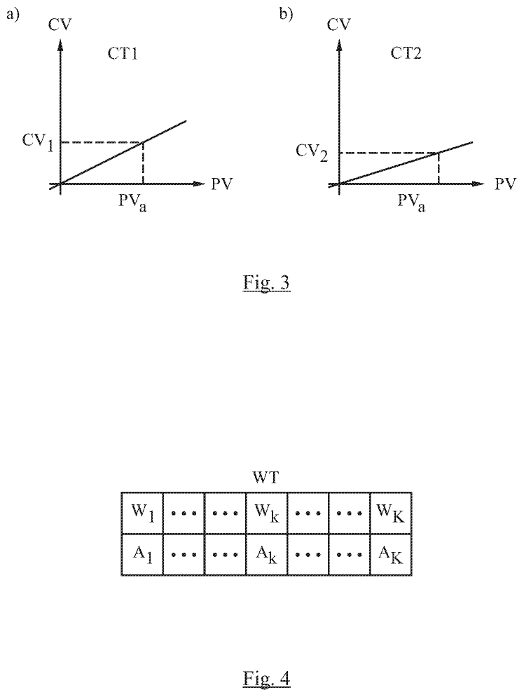

FIG. 2 is a schematic illustration of a plurality of pixels 20 according to an example. In a printing process, the print medium 10 of FIG. 1 or a part thereof may be printed according to printing information contained in the plurality of pixels 20 comprising a digital representation of an image to be printed on the print medium 10, e.g. a printing screen, such that the settings of the printing process may be individually set for each pixel of the plurality of pixels 20. The plurality of pixels may represent the entire print medium 10 or a part thereof.

The plurality of pixels 20 may for example contain, for each pixel representing the print medium 10, a raw printing value, wherein each raw printing value may be representative a color value to be printed on the print medium 10. For example, for a given color of a printing fluid used for printing, for instance ink, a higher raw printing value may represent a darker tonality of said given color achieved by a higher amount of ink, and a lower raw printing value may represent a clearer tonality of said given color achieved by a lower amount of ink.

Each pixel of the plurality of pixels may hence define a raw printing value for a corresponding region of the print medium 10 to be printed with printing fluid according to said raw printing value.

The plurality of pixels 20 forms an array of pixels with pixels in the same row corresponding to locations of the print medium 10 arranged in a direction perpendicular to the direction P of movement of the print medium 10 shown in FIG. 1, and with pixels in the same column corresponding to locations of the print medium 10 arranged in parallel to the direction P of printing shown in FIG. 1. Also shown in FIG. 2 is a plurality of raw printing values Xᵢⱼ for respective pixels of the plurality of pixels 20.

The plurality of pixels 20 of FIG. 2 is shown to comprise M×N pixels as an example, arranged in M rows and N columns. The number of pixels can be adapted to a size of the print medium 10 or a part thereof to be represented and to a desired resolution. For example, if the plurality of pixels 20 should represent the entire print medium 10 and the print medium 10 is an A4 size paper, the print medium 10 may be digitally represented by a plurality of pixels comprising 596×842 pixels at a resolution of 72 dots per inch (DPI), or 2481×3508 pixels at a resolution of 300 DPI, or 4961×7016 at a resolution of 600 DPI. If the print medium 10 is an A3 size paper, the print medium 10 may be digitally represented by a plurality of pixels comprising 842×1191 pixels at a resolution of 72 dots per inch (DPI), or 3508×4961 pixels at a resolution of CT10 DPI, or 7016×9922 at a resolution of 600 DPI. These are just examples and the print medium may also have other sizes and the plurality of pixels be configured for other resolutions.

The transition from a digital color value provided by the plurality of pixels 20 to a real color as printed on the print medium 10 is achieved by means of a calibration table determining a correspondence between raw printing values and an amount of printing fluid, such as ink, to be printed on the print medium in a corresponding pixel in order to print according to said raw printing value. A calibration table may hence associate with each raw printing value a calibration value indicative of an amount of printing fluid required for printing on the print medium according to each given raw printing value. A calibration table may also be referred to as “linearization” or “CLC table”.

FIGS. 3a and 3b are schematic illustrations of first and second calibration tables CT1, CT2 according to an example, respectively. The first calibration table CT1 and the second calibration table CT2 are represented as plots determining corresponding relationships or correspondences between raw printing values PV and calibration values CV. In some examples, each calibration value may correspond, according to the respective calibration table, to a number of drops, a drop volume or a drop weight of printing fluid. The first and second calibration tables CT1, CT2 may hence define a relationship between raw printing values PV or color values and an amount of printing fluid required for printing the corresponding raw printing value on the print medium 10.

The first calibration table CT1, illustrated in FIG. 3a, may provide a first relationship between raw printing values and calibration values configured for a printing process in the first zone 12 of the print medium 10. The second calibration table CT2, illustrated in FIG. 3b, may be configured for defining a second relationship between raw printing values and calibration values for a printing process in the second 14 of the print medium 10. Thus, each of the first calibration table CT1 and the second calibration table CT2 may be configured for taking into account corresponding ambient conditions of a printing process in the first zone 12 and the second zone 14, respectively, of the print medium 10. Differences between the first calibration table CT1 and the second calibration table CT2 may hence reflect a different amount of printing fluid required for printing a given (the same) color value in the first zone 12 and the second zone 14 respectively, due to different ambient conditions. A printing value PVₐ may correspond according to the first calibration table CT1 to a first calibration value CV1 and to a second calibration value CV2 according to the second calibration table CT2, wherein the second calibration value CV2 may be different from the first calibration value CV1.

Ambient conditions of a printing process in the first zone 12 may differ from ambient conditions of the printing process in the second zone 14. If, as exemplarily illustrated in FIG. 1, the first zone 12 is a leading edge zone and the second zone 14 is a rest zone, such different ambient conditions or printing conditions may be due to the presence of a vacuum used for holding the print medium 10 or the presence of an airflow for influencing the transfer of printing fluid to the print medium 10, which may differently affect the print medium 10 in the leading edge zone 12 and in the rest zone 14 due to the geometry of the print medium 10. For example, the interaction of a vacuum or an airflow with a frontal edge 16 (comprised in the leading edge zone 12) of the print medium 10 may create turbulences that are not created in the rest zone 14. If the first and second zones 12, 14 do however not correspond to a leading edge zone and a rest zone respectively, but to different zones comprising different parts of the print medium 10, the different ambient conditions or printing conditions may be due to other differences between the first and second zones 12, 14, such as differences in the material properties of the print medium or differences in structural properties of a printing device.

FIG. 3 is a schematic illustration of a weighting table WT that comprises a plurality of weighting factors W₁, . . . , Wₖ, . . . , W_{K}. The weighting factors may in some examples be numbers comprised between 0 and 1. The different weighting factors W₁, . . . , W_{K} may be associated with pixels corresponding to different positions of the print medium 10 along the direction of movement P of the print medium 10, such that each weighting factor Wₖ is associated with a position of the corresponding pixel along the direction of movement P.

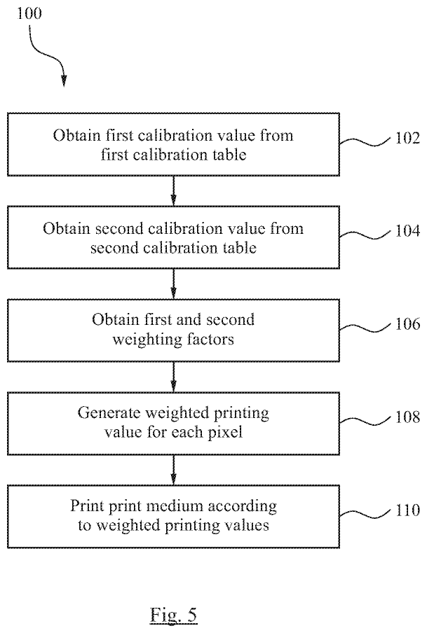

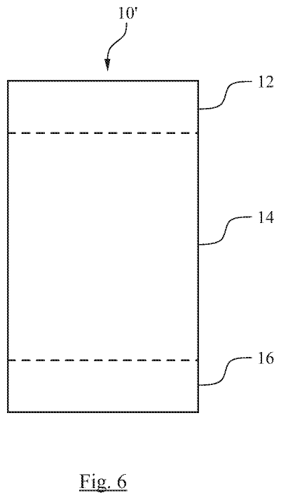

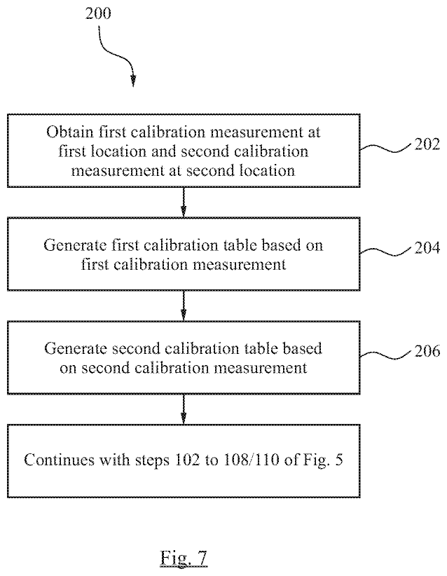

As schematically illustrated in FIG. 5, a method 100 of calibrating a printing device may comprise associating a weighted printing value WPV to each of a plurality of pixels 20 by obtaining, at 102, from a first calibration table CT1, a first calibration value D1. Obtaining, at 104, from a second calibration table CT2, a second calibration value D1′. Obtaining, at 106, first and second weighting factors W₁ and W₂, wherein the first weighting factor W₁ is obtained from a weighting table WT. The method further comprises, at 108, generating the weighted printing value WPV as the sum of the first calibration value weighted with the first weighting factor and the second calibration value weighted with the second weighting factor. The method 100 may further comprise, abt110, printing the print medium 10 according to the weighted printing values WPV.

The first weighting factor may be read or obtained from the weighting table WT. In some examples, the second weighting factor may be obtained as a function of the first weighting factor, for example as 1 minus the first weighting factor. Thus, for each pixel, a weighted printing value may be defined for each pixel as WPVᵢⱼ=CV1·Wᵢ+CV2·(1−Wᵢ), Wᵢ being the first weighting factor obtained from the weighting table WT for the given pixel, CV1 and CV2 being the calibration values respectively obtained from the first and second calibration tables CT1 and CT2 for the raw printing value Xᵢⱼ originally associated with the given pixel. Thus, WPVᵢⱼ is the weighted printing value generated for the pixel that was originally associated with the raw printing value Xᵢⱼ. In other examples, the second weighting factor may also be obtained from the weighting table WT.

The weighting factors of the weighting table associated with pixels at different positions along the direction of movement P of the print medium 10 may vary along this direction P. In some examples, the first weighting factors associated with pixels at different positions along the direction of movement P of the print medium 10 may decrease along this direction, at least for some part of the print medium 10, such that pixels representing positions of the print medium 10 arranged further down the direction of movement P may be associated with lower first weighting factors. Accordingly, the second weighting factors associated with pixels at different positions along the direction of movement P of the print medium 10 may increase along the direction of movement P, at least for some part of the print medium 10.

For example, a pixel of an uppermost row of pixels representing an uppermost region of the print medium 10 in a first zone 12 that is a leading edge zone may be associated with a first weighting factor of 1 and a second weighting factor of 0, such that the weighted printing value corresponds to the first calibration value. A pixel of a lowermost row of pixels representing a region of the print medium 10 in a second zone 14 that is a rest zone may be associated with a first weighting factor of 0 and a second weighting factor of 1, such that the weighted printing value corresponds to the second calibration value.

Intermediate pixels of intermediate rows of pixels may be associated with a first weighting factor and a second weighting factor, wherein the values of the first weighting factors may decrease along the direction of movement P of the print medium 10 and the values of the second weighting factors may increase along the direction of movement P, such that the weight of the first calibration values upon the weighted printing values may decrease along the direction of movement P and the weight of the second calibration values upon the weighted printing values may increase along the direction of movement P.

In some examples, the weighting factors of the weighting table associated with pixels at different positions along the direction of movement P of the print medium 10 may vary, in particular increase or decrease, along the direction of movement P according to a predefined function, which may be a linear function, quadratic function, a polynomial function, a logarithmic function, or an exponential function.

In some examples, the weighting factors associated with pixels located at equal positions along the direction P may be the same. Thus, pixels in the same row of pixels of the array formed by the plurality of pixels 20 shown in FIG. 2 may be associated with the same first and second weighting factors and hence to the same weighted printing value. With reference to the expression introduced above, this means that, for each pixel, a weighted printing value may be defined for each pixel as WPVᵢⱼ=CV1·Wᵢ+CV2·(1−Wᵢ), for j=1, . . . , N, with N being the number of columns of pixels of the plurality of pixels 20.

In some examples, the same first and second weighting factors may be used for obtaining the weighted printing values corresponding to a predefined number of consecutive rows of pixels. The weighting table WT may comprise, for each weighting factor Wₖ, a numerical value Aₖ indicating the number of consecutive rows of pixels to which each weighting factor Wₖ is to be associated. For example, if the weighting table WT comprises, as a first entry, a weighting factor W₁ and a corresponding numerical value A₁, the weighting factor W₁ may be used as a first weighting factor for the first A₁ rows of pixels of the plurality of pixels 20. Then, if the weighting table WT further comprises, as a second entry following the first entry, a weighting factor W₂ and a corresponding numerical value A₂, the weighting factor W₂ may be used as a first weighting factor for the A₂ rows of pixels of the plurality of pixels 20 following the A1-th row and so forth.

The value of the predefined numbers Aₖ may vary along the direction of movement P of the print medium 10, i.e. along the weighting table WT, such that successive weighting factors of the weighting table may be associated with different numbers of consecutive rows of pixels, wherein said different numbers of consecutive rows of pixels may increase or decrease along the direction of movement P.

With reference to the expression introduced above, this means that, for each pixel, a weighted printing value may be defined for each pixel as WPVᵢⱼ=CV1·Wᵢ+CV2·(1−Wᵢ), for j=1, . . . , N, with N being the number of columns of pixels of the plurality of pixels 20, and for i=i₀, . . . , i₀+(Aᵢ−1), with Aᵢ being the numerical value determined by the weighting table WT for the Aᵢ rows of pixels starting with the i₀-th row of pixels. Aᵢ₊₁ may be different from Aᵢ, Aᵢ₊₂ may be different from Aᵢ₊₁ and so forth.

The print medium 10 may be printed according to the weighted printing values WPV associated with each pixel. Thus, each pixel may be printed according to the weighted sum of the first and second calibration values, respectively obtained from the first and second calibration tables, wherein the weight of each of the calibration values in the weighted printing value is determined by the weighting table. Each weighted printing value and each of the first and second calibration values may correspond to one of a color value, a drop weight, a drop volume, or a number of drops.

Thereby, a weighted smooth transition between the calibration values obtained from the first calibration table (first linearization), which may be specially configured for printing in the first zone 12, and the calibration values obtained from the second calibration table (second linearization), which may be specially configured for printing in the second zone 14, can be achieved. This allows avoiding the appearance of visible printing irregularities on the print medium that would otherwise arise due to different ambient conditions in the first zone 12 and the second zone 14, such as bandings, throughout the print medium, both in the first zone 12 and in the second zone 14. Since the values of the weighting factors of the weighting table may vary as a function of a position of the corresponding pixels or rows of pixels along the direction P of movement of the print medium 10, the weight of the first calibration table may gradually diminish along the print medium in the direction P as the weight of the second calibration table gradually increases along set direction P.

Although examples have been described referring to a first zone and to a second zone, the number of zones of the print medium may be higher, for example three, four or five. In some examples, the first weighting factors associated with pixels at different positions along the direction of movement P of the print medium 10 may decrease along this direction for some part of the print medium 10 and then increase for some other part of the print medium 10, as the corresponding second weighting factors associated with said pixels at different positions along the direction of movement P of the print medium 10 first increase along the direction of movement P for said some part of the print medium 10 and then decrease for said some other part of the print medium 10.

FIG. 6 schematically illustrates a print medium 10 according to an example, wherein the first weighting factors may start increasing again for pixels of the plurality of pixels 20 representing locations of the print medium 10 comprised in or close to a third zone 16 of the print medium 10, which as exemplarily illustrated in FIG. 6, may be a tail edge zone 16 of the print medium 10 comprising an edge of the print medium located opposite to the first zone 12 (or leading edge zone 12). When the first weighting factors start increasing again, the first calibration table CT1 may be replaced by a third calibration table CT3 specially configured for printing in the third zone 16, i.e. taking into account ambient conditions in the third zone 16.

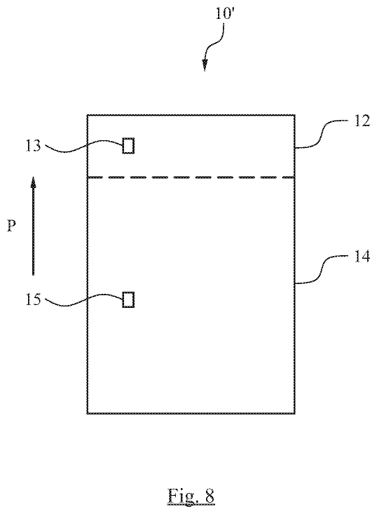

The first and second (and optionally third) calibration tables may be predefined calibration tables, for example pre-stored in a calibration unit, or may be obtained as part of a method of calibrating a printing device. FIG. 7 is a flow diagram schematically illustrating such a method and FIG. 8 is a schematic illustration of a test print medium 10′, which may be a printed test print medium that has already undergone a test printing process. The test printing process may comprise printing predefined color values at predefined locations of the test print medium 10′, which may then be used for obtaining the first and second calibration measurements.

The test print medium 10′ is divided in a first zone 12 and a second zone 14, which in the illustrated example of FIG. 8 respectively are a leading edge zone 12 and a rest zone 14, like in the print medium 10 illustrated in FIG. 1. The leading edge zone 12 may extend from a leading edge of the test print medium 10′ for ⅓, ¼, ⅕, ⅛, or 1/20 of a length of the test print medium along the direction of movement P of the test print medium.

Also indicated in FIG. 8 are a first location 13 of the test print medium 10′ and a second location 15 of the test print medium 10′. The first location 13 and the second location 15 are spaced apart in the direction of movement P of the test print medium 10′. In some examples, the first location 13 may be arranged in the first zone 12 and the second location 15 may be arranged in the second zone 14.

The method illustrated in FIG. 7 may comprise, at 202, obtaining a first calibration measurement of a printing parameter at the first location 13 of the test print medium 10′ and a second calibration measurement of the printing parameter at the second location 15 of the test print medium 10′. The printing parameter may correspond to or be a color value printed on the test print medium 10′. The first and second calibration measurements may be obtained by one or a plurality of sensors for measuring the printing parameter. For example, the sensor(s) may be sensors integrated in a printing device for measuring the first and second printing parameters after or while the test print medium 10′ is printed at the printing device. For example, the sensors may be configured for measuring a color value or a parameter related to an amount of printing fluid, such as a number of drops of printing fluid.

At 202, the method 200 may further comprise obtaining further calibration measurements of the printing parameter at further locations of the test print medium 10′ spaced apart from the first and second locations 13, 15 and may further comprise obtaining further calibration measurements of the printing parameter at each of the first and second locations 13, 15.

At 204, a first calibration table CT1 is generated for the printing parameter based on the first calibration measurement. Generating the first calibration table CT1 may comprise recalibrating a pre-existing calibration table based on the first calibration measurement. For example, if a pixel corresponding to the first location 13 should, according to the pre-existing calibration table, be printed with a given color value CV1, the first calibration measurement may determine that said pixel is printed on the test print medium 10′ with a real color value CV1′ that differs from said given color value CV1. This may be due to the ambient conditions in the first zone 12. In that case, the first calibration table CT1 may be generated by correspondingly recalibrating the pre-existing calibration table such that the calibration value associated with said given color value CV1 according to the first calibration table be such that the pixel corresponding to the first location 13 is printed with the color value CV1.

At 206, a second calibration table CT2 is generated for the printing parameter based on the second calibration measurement. The process of generating the second calibration table CT2 may be analogous to the process of generating the first calibration table CT1. The second calibration table CT2 may be generated by correspondingly recalibrating another preexisting calibration table such that a calibration value associated with a given color value CV2 according to the second calibration table be such that a pixel corresponding to the second location 15 is actually printed with the color value CV2, taking into account ambient conditions in the rest zone 14.

After 206, the method may continue with blocks 102 to 108 or 102 to 110 illustrated and explained above with respect to FIG. 5. If the first and second locations are respectively located in the first zone 12 and the second zone 14, the method represented in FIG. 7 may allow recalibrating pre-existing calibration tables that are especially configured for taking into account ambient conditions in the first zone 12 and the second zone 14, respectively, thereby generating first and second calibration tables that are further configured to take into account, besides the difference between the first zone 12 and the second zone 14, also differences between real printing conditions, for example at a consumer end, and design printing conditions, for example at a manufacturing end. Thus, the method illustrated in FIG. 7 may allow a user generating the first and second calibration tables CT1 and CT2 such that the influence of a particular printing fluid or of a particular print medium is taken into account.

In some examples, the method 200 may further comprise obtaining a third calibration measurement of the printing parameter at a third location of the test print medium 10′, wherein the third location may be arranged spaced apart from the first location and from the second location in the direction of movement P. The third location may be arranged in a third zone of the test print medium 10′, for example in a tail edge zone analogous to the tail edge zone 16 described with respect to FIG. 6. For pixels in the third zone 16, weighted printing values may be generated replacing the first calibration table by the third calibration table, i.e., as the sum of the second calibration weighted with specific weighting factor and a third calibration value weighted with a third weighting factor.

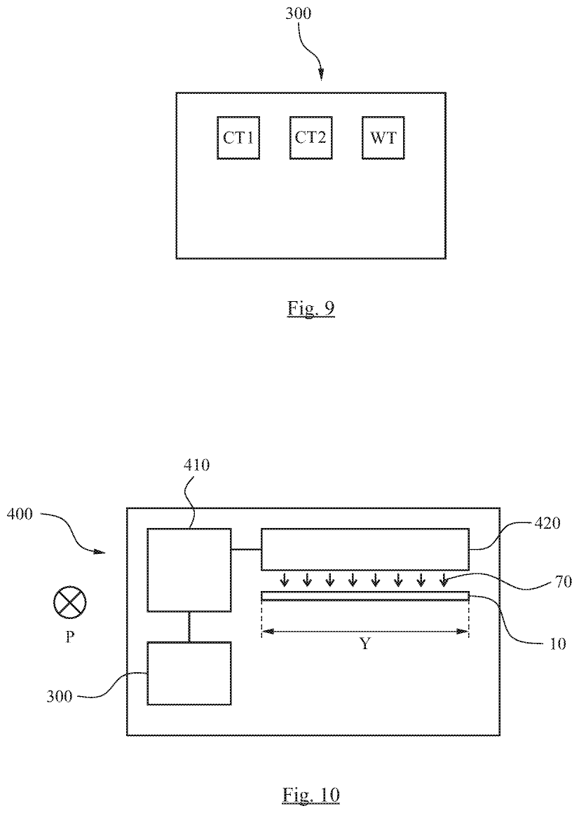

FIG. 9 is a schematic illustration of a calibration unit 300 according to an example. The calibration unit 300 may comprise a first calibration table CT1, a second calibration table CT2, and a weighting table WT as described above. In other examples, the calibration unit 300 may comprise further calibration tables, for example a third calibration table CT3 as explained above.

The calibration unit 300 may be a hardware-based calibration module 300 connectable or connected to a printing device and configured to implement a method of calibrating the printing device according to any of the previously described examples. The calibration unit 300 may however also be a calibration unit 300 comprising machine readable instructions which, when executed by a processor, cause the processor to implement a method of calibrating a printing device according to any of the previously described examples. Such calibration unit comprising machine readable instructions may be in the form of program code stored in the calibration unit 300.

FIG. 10 is a schematic illustration of a printing device 400 to print a print medium 10 with a printing fluid 70, for example ink. The printing device 400 shown in FIG. 10 may be a page-wide printer comprising a printhead 420 covering the entire width Y of the print medium 10 along a direction perpendicular to the direction of movement P of the print medium 10 with respect to the printhead 420. In FIG. 10, the direction of movement P corresponds to a direction perpendicular to the plane of the sheet, as indicated with a cross. A page-wide printer allows printing the entire print medium without having to move the printhead 420 with respect to the print medium 10 in a direction perpendicular to the direction of the movement P.

The printing device 400 further comprises a processing unit 410 connected to the printhead 420 to generate a printing mask comprising a plurality of pixels, like the plurality of pixels 20 shown in FIG. 2, wherein each pixel is associated with a raw printing value Xᵢⱼ. The plurality of pixels 20 may be a digital representation of an image to be printed on the print medium 10 or a part thereof and the raw printing values Xᵢⱼ may be indicative of a color value to be printed for each pixel on the print medium 10.

The processing unit 410 controls the printhead 420 to print the print medium 10 with the printing fluid 70 according to the printing mask, i.e. according to the raw printing values Xᵢⱼ of the plurality of pixels 20. The printing fluid may be ink, which may be fired by the printhead 420 on the print medium 10 in a direction perpendicular to the plane of the print medium and to the direction of movement P of the print medium, as indicated in FIG. 10.

The printing device may further comprise the calibration unit 300 illustrated in FIG. 9 connected the processing unit 410. The processing unit 410 may be configured to associate with each pixel of the printing mask a weighted printing value WPV generated as the sum of a corresponding first calibration value CV1, obtained from a first calibration table CT1 of the calibration module 300, weighted with a first weighting factor WF1, obtained from a weighting table WT of the calibration module 300, and a corresponding second calibration value CV2, obtained from a second calibration table CT2 of the calibration module 300, weighted with a second weighting factor WF2, obtained from the weighting table WT of the calibration module 300.

1. A method of calibrating a printing device, wherein the method comprises:
associating a weighted printing value to each of a plurality of pixels, wherein associating a weighted printing value to each pixel comprises:
obtaining, from a first calibration table, a first calibration value;
obtaining, from a second calibration table, a second calibration value;
obtaining first and second weighting factors, wherein the first weighting factor is obtained from a weighting table,
generating the weighted printing value as the sum of the first calibration value weighted with the first weighting factor and the second calibration value weighted with the second weighting factor.

2. The method of claim 1, wherein each weighted printing value and each of the first and second calibration values corresponds to one of a color value, a drop weight of printing fluid, and a number of drops of printing fluid.

3. The method of claim 1, wherein obtaining the first weighting factor from the weighting table comprises obtaining from the weighting table a weighting factor associated with a position of the pixel along a direction of movement of the print medium.

4. The method of claim 3, wherein weighting factors associated with pixels at equal positions along the direction of movement of the print medium have equal values.

5. The method of claim 1, wherein the second weighting factor is obtained as a function of the first weighting factor.

6. The method of claim 1, wherein the plurality of pixels are arranged in rows of pixels perpendicular to a direction of movement of the print medium, wherein first and second weighting factors having equal value are used for obtaining the weighted printing values corresponding to a predefined number of consecutive rows of pixels.

7. The method of claim 6, wherein the weighting table comprises, for each first weighting factor, a numerical value indicating said predefined number of rows of pixels to which each first weighting factor is to be applied.

8. The method of claim 6, wherein said predefined number varies along the direction of movement of the print medium.

9. The method of claim 1, further comprising printing a print medium according to the weighted printing values associated with each pixel.

10. A method of calibrating a printing device comprising:
obtaining a first calibration measurement of a printing parameter at a first location of a test print medium and a second calibration measurement of the printing parameter at a second location of the test print medium, wherein the first and second locations are spaced apart in a direction of movement of the test print medium;
generating a first calibration table for the printing parameter based on the first calibration measurement;
generating a second calibration table for the printing parameter based on the second calibration measurement;
associating a weighted printing value to each of a plurality of pixels, wherein associating a weighted printing value to each pixel comprises:
obtaining a first calibration value from the first calibration table;
obtaining a second calibration value from the second calibration table;
obtaining first and second weighting factors, wherein the first weighting factor is obtained from a weighting table, and
generating the weighted printing value as the sum of the first calibration value weighted with the first weighting factor and the second calibration value weighted with the second weighting factor.

11. The method of claim 10, wherein the first location is located within a leading edge zone of the test print medium extending from a leading edge of the test print medium for ⅓, ¼, ⅕, ⅛, or 1/20 of a length of the test print medium along the direction of movement of the test print medium.

12. The method of claim 10, wherein each first weighting factor is associated with a position of the corresponding pixel along the direction of movement of the test print medium.

13. The method of claim 10, further comprising obtaining a third calibration measurement of the printing parameter from a third location of the test print medium, wherein the third location is spaced apart from the first and second locations in the direction of movement of the print medium;
generating a third calibration table for the printing parameter in the third location based on the third calibration measurement;
wherein associating the weighted printing value to each pixel further comprises:
obtaining a third calibration value from the third calibration table;
obtaining a third weighting factor;
generating a weighted printing value as the sum of the second calibration value weighted with the second weighting factor and the third calibration value weighted with the third weighting factor.

14. A printing device comprising:
a processing unit to generate a printing mask comprising a plurality of pixels, wherein each pixel is associated with a raw printing value,
a printhead to print a print medium with a printing fluid according to the printing mask; and
a calibration unit comprising:
a first calibration table associating a first calibration value to each raw printing value;
a second calibration table associating a second calibration value to each raw printing value; and
a weighting table associating a first weighting factor to each pixel as a function of the position of the pixel along a direction of movement of the print medium with respect to the printhead,
wherein the processing unit is configured to associate with each pixel of the printing mask a weighted printing value generated as the sum of the corresponding first calibration value weighted with the first weighting factor and the corresponding second calibration value weighted with a second weighting factor.

15. The printing device of claim 14, wherein the printing device is a page-wide printer, wherein the printhead covers the entire width of the print medium along a direction perpendicular to the direction of movement of the print medium with respect to the printhead.
